(19) United States
(12) Patent Application Publication
(10) Pub. No.: US 2010/0088729 A1
(43) Pub. Date: Apr. 8, 2010

(54) Microwave frequency satellite signal reception installation

(75) Inventor: Kamal Lotfy, Hanches (FR)

Correspondence Address: Davidson, Davidson & Kappel, LLC, 485 7th Avenue, 14th Floor, New York, NY, 10018, US

(73) Assignee: EUTELSAT, Paris (FR)

(21) Appl. No.: 12/321,892

(22) Filed: Jan. 27, 2009

(30) Foreign Application Priority Data
Oct. 6, 2008 (FR) FR 08/56762

(51) Int. Cl. H04N 7/20

(52) U.S. Cl. 725/69

(57) ABSTRACT

The present invention relates to an installation for receiving microwave frequency radio satellite signals, said installation comprising a first electric adder to add a first electrical signal representative of a radio signal according to a first polarization and transposed to a first intermediate band and a second electrical signal representative of a radio signal according to a first polarization and transposed to a second intermediate band and a second electric adder to add a first electrical signal representative of a radio signal according to a second polarization and transposed to the first intermediate band and a second electrical signal representative of a radio signal according to a second polarization and transposed to a second intermediate band.

This claims the benefits of French Patent Application FR 08/56762, filed on Oct. 6, 2008, and hereby incorporated by reference herein.

### BACKGROUND

The present invention relates to a microwave frequency satellite signal reception installation.

Currently, broadcasting programs by satellite is widely used across the world. Numerous devices are installed in millions of users' homes. The devices installed are predominantly reception devices that comprise an outer unit including a parabolic reflector that focuses the modulated microwave frequency signals onto the source, known as a horn, of an LNB (Low Noise Block), the LNB transforming the microwave frequency signals received into electrical signals in intermediate satellite band in order to transmit them through a coaxial cable to an internal unit, generally called a satellite decoder or even STB (“Set Top Box”). The decoder comprises a demodulation block that extracts a “useful” modulated signal in the modulated signal transmitted over the coaxial cable and demodulates the “useful” signal extracted. The demodulated “useful” signal may, for example, be used to display video images on a television screen.

Generally, the modulated signal received by the LNB block has an initial frequency band that extends, for example, between 10.7 GHz and 12.75 GHz, which corresponds to the frequency band Ku used for transmitting signals between a satellite and a ground receiving station. This band is separated by the LNB block into a low band ranging from 10.7 GHz to 11.7 GHz and a high band ranging from 11.7 GHz to 12.75 GHz. Each low or high band is divided into frequency channels, the frequency band of each “useful” modulated signal being included in one of the frequency channels.

In addition, an LNB is designed to allow the reception of polarized signals. Polarization may be, for example, linear (horizontal or vertical), or even circular (right or left).

Thus, in the case of broadcasting in Ku band and in linear polarization, there are four possible states:

A high frequency band in vertical polarization HV;

A low frequency band in vertical polarization BV;

A high frequency band in horizontal polarization HH;

A low frequency band in horizontal polarization BH.

For each state, the LNB block is going to amplify the signal received with the smallest possible noise factor and convert the signal received from the initial high or low frequency band to a frequency band, called a transmission band, that is suitable for the coaxial cable bandwidth and to the frequency band of the decoder, typically between 950 MHz to 2150 MHz.

However, such a solution poses some difficulties.

In fact, when one wishes to serve several decoders (i.e., several users) from the same parabola, it is then necessary to use several coaxial cables dedicated to the receivers. The multiplication of coaxial cables presents a significant cost, each cable necessitating the presence of connectors, in addition to the installation and maintenance of said cables.

In addition, it may be desirable for a decoder to be able to process several useful signals of different polarizations at the same time. It may also be desirable for a decoder to be able to process several useful signals from initial signals having different initial frequency bands (for example, in high or low band or bands from different satellites in the case of an antenna for multiple orbits) at the same time. Again, it is then necessary to use several coaxial cables.

### SUMMARY OF THE INVENTION

A known solution to this problem consists of using the technology known as UNICABLE™ to serve several satellite receivers; such a technology is notably described in the standard CENELEC EN 50494 or in patent application FR2835368. This solution consists of having a single down-lead coaxial cable and then of having a distributor (signal division). Each receiver will have a dedicated carrier (known as a “user band”) inside the 950-2150 spectrum operating at a fixed frequency: the content of each frequency is fixed at the level of the LNB module utilizing the UNICABLE™ technology. Thus, the content of each “user band” varies according to the command sent by the receiver to the LNB UNICABLE™ module: the frequency is selected at the LNB module. To do this, the LNB module comprises a switch matrix with at least 4 inputs (corresponding to the 4 states mentioned above) and 4 outputs (for each receiver having a dedicated “user band” with the requested content). Such a technology presents the advantage of only using a single coaxial cable.

However, this solution poses some difficulties; in fact, the switch matrices have a limited number of inputs (typically 4 inputs corresponding to four states coming from a satellite or 8 inputs corresponding to four states coming from two satellites in two orbital positions). Consequently, the limited number of switch matrix inputs does not allow the system to be changed by allowing the users to receive another band coming from a new satellite with the same antenna. By way of example, an installation allowing the receipt of signals from Ku band satellites corresponding to two orbital positions 13° East and 9° East does not allow the receipt of signals from a Ka band satellite (band 19.7 GHz-20.2 GHz) at 13° East.

It is an object of the invention to provide a microwave frequency radio satellite signal reception installation that is free of the aforementioned problems.

For this purpose, the invention proposes a microwave frequency radio satellite signal reception installation, said installation comprising:

A first block including:

First means to transform:

A first initial radio signal according to a first polarization from a first satellite in a first frequency band into a first electrical signal representative of said first initial radio signal according to a first polarization and,

A first initial radio signal according to a second polarization from said first satellite in said first frequency band into a first radio signal representative of said first initial radio signal according to a second polarization;

A first local oscillator to generate a first transposition signal at a given oscillation frequency;

A first frequency mixer having:

A first input to receive said first electrical signal representative of said first initial radio signal according to a first polarization and,

A second input receiving said first transposition signal such that said first mixer shifts the first initial frequency band of the first electrical signal representative of said first initial radio signal according to a first polarization to a first intermediate frequency band;

A second frequency mixer having:

A first input to receive said first electrical signal representative of said first initial radio signal according to a second polarization and,

A second input receiving said first transposition signal such that said second mixer shifts the first initial frequency band of the first electrical signal representative of said first initial radio signal according to a second polarization to said first intermediate frequency band;

A second bloc including:

A second local oscillator to generate a second transposition signal at a given oscillation frequency;

Second means to transform:

A second initial radio signal according to a first polarization from a second satellite in a second frequency band into a second electrical signal representative of said second initial radio signal according to a first polarization and,

A second initial radio signal according to a second polarization from said second satellite in said second frequency band into a second electrical signal representative of said second initial radio signal according to a second polarization;

A third frequency mixer having:

A first input to receive said second electrical signal representative of said second initial radio signal according to a first polarization and,

A second input receiving said second transposition signal such that said third mixer shifts the second initial frequency band of the second electrical signal representative of said second initial radio signal according to a first polarization to a second intermediate frequency band;

A fourth frequency mixer having:

A first input to receive said second electrical signal representative of said second initial radio signal according to a second polarization and,

A second input receiving said second transposition signal such that said fourth mixer shifts the second initial frequency band of the second electrical signal representative of said second initial radio signal according to a second polarization to said second intermediate frequency band;

Said installation being characterized in that it comprises:

A first electric adder to add the first transposed signal to said first intermediate band from the first electrical signal representative of said first initial radio signal according to a first polarization and the second transposed signal to said second intermediate band from said second electrical signal representative of said second initial radio signal according to a first polarization;

A second electric adder to add the first transposed signal to said first intermediate band from said first electrical signal representative of said first initial radio signal according to a second polarization and the second transposed signal to said second intermediate band from said second electrical signal representative of said second initial radio signal according to a second polarization.

Thanks to the invention, microwave frequency coupling is done between inputs before injecting them in a switch matrix implementing the UNICABLE™ technology. The entire spectrum of the allocated band is not necessarily used by a satellite. By way of example, we consider that only the 11.2 GHz to 11.7 GHz part of the low part of the Ku band is used as the first initial frequency band. According to the invention, this first 11.2 GHz-11.7 GHz band is converted, for the two polarizations, into one first 1450 MHz-2150 MHz intermediate band by using a first local oscillator at 9.75 GHz. By taking the Ka band ranging from 19.7 GHz to 20.2 GHz as the second initial frequency band, this second frequency band is converted, for the two polarizations, into a second intermediate band between 950 MHz et 1450 MHz by using a second local oscillator at 18.75 GHz. The signals according to each of the two polarizations respectively corresponding to the adjacent intermediate bands 950 MHz-1450 MHz and 1450 MHz-2150 MHz are then electrically added by an adder that carries out microwave frequency coupling between the two signals. Each of the signals corresponding to a polarization may then be used as an input of a switch matrix for the implementation of UNICABLE™ technology.

The installation according to the invention thus allows different bands such as Ku and Ka bands from geostationary satellites to be received with the same antenna while using UNICABLE™ technology to serve several satellite receivers and by using the properties of the switch matrices, with limited numbers of inputs, to the maximum.

The installation according to the invention may also present one or more of the following characteristics, considered individually or according to all technically possible combinations:

Preferentially, said oscillation frequencies of said first and second local oscillators are chosen such that said first and second intermediate bands are substantially adjacent.

“Substantially adjacent bands” is understood to refer to bands that touch via a common frequency or that are slightly spaced apart (typically approximately 100 MHz), the distance typically being equal to 10% of the low frequency of the high band. In any case, this distance is less than or equal to 200 MHz.

Advantageously, said second block comprises:

A horn for the reception:

Of said second initial radio signal according to the first polarization from a second satellite in said second frequency band;

Of said second initial radio signal according to the second polarization from said second satellite in said second frequency band;

A converter from a circular polarization signal into a linear polarization signal;

Two amplifiers to respectively amplify:

Said second electrical signal representative of said second initial radio signal in vertical polarization and,

Said second electrical signal representative of said second initial radio signal in horizontal polarization.

Advantageously, said first frequency band is the Ku band and said second frequency band is the Ka band.

Preferentially:

Said first local oscillator generates a first transposition signal at a frequency of 9.75 GHz;

Said second local oscillator generates a second transposition signal at a frequency of 18.75 GHz.

According to a particularly advantageous embodiment, said installation is intended to produce a signal in a transmission band to be transmitted over a coaxial cable and said first block comprises:

A horn for the reception:

Of an initial radio signal in vertical polarization from a first satellite in a first frequency band;

Of an initial radio signal in horizontal polarization from said first satellite in said first frequency band;

Means to transform:

Said initial radio signal from the first satellite in vertical polarization in said first frequency band into an electrical signal,

Said initial radio signal from said first satellite in horizontal polarization in said first frequency band into an electrical signal;

first and second amplifiers to respectively amplify said electrical signals;

first and a second passband filters coupled to said first amplifier and respectively allowing a first high frequency band signal representative of said initial radio signal from the first high frequency band satellite in vertical polarization and a first low frequency band signal representative of said initial radio signal from the first low frequency band satellite in vertical polarization to be obtained, said first mixer shifting the first low frequency band signal representative of said initial radio signal from the first low frequency band satellite in vertical polarization to said first low intermediate frequency band;

A third and fourth passband filter coupled to said second amplifier and respectively allowing a first high frequency band signal to be obtained representative of said initial radio signal from the first high frequency band satellite in horizontal polarization and a first low frequency band signal representative of said initial radio signal from the first low frequency band satellite in horizontal polarization to be obtained, said second mixer shifting said first low frequency band signal representative of said initial radio signal from the first low frequency band satellite in horizontal polarization to said first low intermediate frequency band;

A third oscillator generating a third transposition signal at a given oscillation frequency;

A fifth frequency mixer having a first input to receive the output of said first passband filter and a second input to receive the signal generated by said third local oscillator such that said fifth mixer shifts the high frequency band signal of said initial radio signal from the first high frequency band satellite in vertical polarization to a first high intermediate frequency band;

A sixth frequency mixer having a first input to receive the output of said third passband filter and a second input to receive the signal generated by said third local oscillator such that said sixth mixer shifts the high frequency band signal in horizontal polarization representative of said initial radio signal from the first high frequency band satellite in horizontal polarization to the first high intermediate frequency band;

Said first frequency mixer receiving on its first input the output of said second passband filter and said second frequency mixer receiving on its first input the output of said fourth passband filter,

Said installation comprising:

A selector including at least 4 inputs to respectively receive the signals produced by said first electric adder, said fifth frequency mixer, said sixth frequency mixer and said tenth electric adder, said selector may select several signals from among the signals received;

For each signal selected, a mixer capable of transforming the selected signal into a signal at least in part in the transmission band, and a filter capable of extracting from the transformed signal a signal associated with a portion of the transmission band from among several portions of the transmission band;

A third adder to form said signal in the transmission band to be transmitted over said coaxial cable from the signals associated with the portions of said transmission band.

Advantageously, said third local oscillator generates a third transposition signal at a frequency of 10.6 GHz.

Preferentially:

The first high frequency band of said first high frequency band electrical signals representative of initial radio signals from the first high frequency band satellite, respectively in vertical and horizontal polarization, is between 11.7 GHz and 12.75 GHz;

The first low frequency band of said first low frequency band electrical signals representative of initial radio signals from the first low frequency band satellite, respectively in vertical and horizontal polarization, is between 11.2 GHz and 11.7 GHz;

The second frequency band of said second electrical signals is between 19.7 GHz and 20.2 GHz;

Said first low intermediate frequency band is between 1450 MHz and 1950 MHz;

Said first high intermediate frequency band is between 1100 MHz and 2150 MHz;

Said second intermediate frequency band is between 950 MHz and 1450 MHz.

According to a particularly advantageous embodiment, the installation according to the invention comprises a third block including:

A horn for the reception:

Of a third initial radio signal according to a vertical polarization from a third satellite in a third initial frequency band;

Of a third initial radio signal according to a horizontal polarization from a third satellite in a third initial frequency band;

Means for transforming:

Said initial radio signal from said third satellite in vertical polarization in the third frequency band into an electrical signal;

Said initial radio signal from said third satellite in horizontal polarization in the third frequency band into an electrical signal;

Third and fourth amplifiers to respectively amplify said electrical signals;

Fifth and sixth passband filters coupled to said third amplifier and respectively allowing a third high frequency band signal to be obtained representative of said initial radio signal from the third high frequency band satellite according to the vertical polarization and a third low frequency band signal representative of said initial radio signal from the third low frequency band satellite according to the vertical polarization,

Seventh and eighth passband filters coupled to said fourth amplifier respectively allowing a third high frequency band signal representative of said initial radio signal from the third high frequency band according to the horizontal polarization and a third low frequency band signal representative of said initial radio signal from the third low frequency band satellite according to the horizontal polarization to be obtained;

A fourth oscillator generating a fourth transposition signal at a given oscillation frequency;

A fifth oscillator generating a fifth transposition signal at a given oscillation frequency;

A seventh frequency mixer having a first input to receive the output of said sixth passband filter and a second input to receive the signal generated by said fourth local oscillator such that said seventh mixer shifts the third low frequency band signal representative of said initial radio signal from the third low frequency band satellite according to the vertical polarization to a third high intermediate frequency band;

An eighth frequency mixer having a first input to receive the output of said fifth passband filter and a second input to receive the signal generated by said fifth local oscillator such that said eighth mixer shifts the third high frequency band signal representative of said initial radio signal from the third high frequency band satellite according to the vertical polarization to a third high intermediate frequency band;

A ninth frequency mixer having a first input to receive the output of said seventh passband filter and a second input to receive the signal generated by said fifth local oscillator such that said ninth mixer shifts the third high frequency band signal representative of said initial radio signal from the third high frequency band satellite according to the horizontal polarization to the third high intermediate frequency band;

A tenth frequency mixer having a first input to receive the output of said eighth passband filter and a second input to receive the signal generated by said fourth local oscillator such that said tenth mixer shifts the third low frequency band signal representative of said initial radio signal from the third low frequency band satellite according to the horizontal polarization to the third low intermediate frequency band;

Said selector including 8 inputs to respectively receive the signals produced by said seventh frequency mixer, said eighth frequency mixer, said ninth frequency mixer, said tenth frequency mixer, said first electric adder, said fifth frequency mixer, said sixth frequency mixer and said tenth electric adder.

Advantageously, said third frequency band is the Ku band, said fourth local oscillator generates a first transposition signal at a frequency of 9.75 GHz and said fifth local oscillator generates a tenth transposition signal at a frequency of 10.6 GHz.

Advantageously, said means for transforming radio signals into electrical signals comprise two antenna ends.

### BRIEF DESCRIPTION OF THE DRAWINGS

Other characteristics and advantages of the invention will clearly emerge from the description given below, for indicative and in no way limiting purposes, with reference to the attached figures, among which:

FIG. 1 is a simplified schematic representation of-a installation according to the invention;

FIG. 2 illustrates the conversions of initial frequency bands into intermediate frequency bands.

In all figures, common elements carry the same reference numbers.

### DETAILED DESCRIPTION

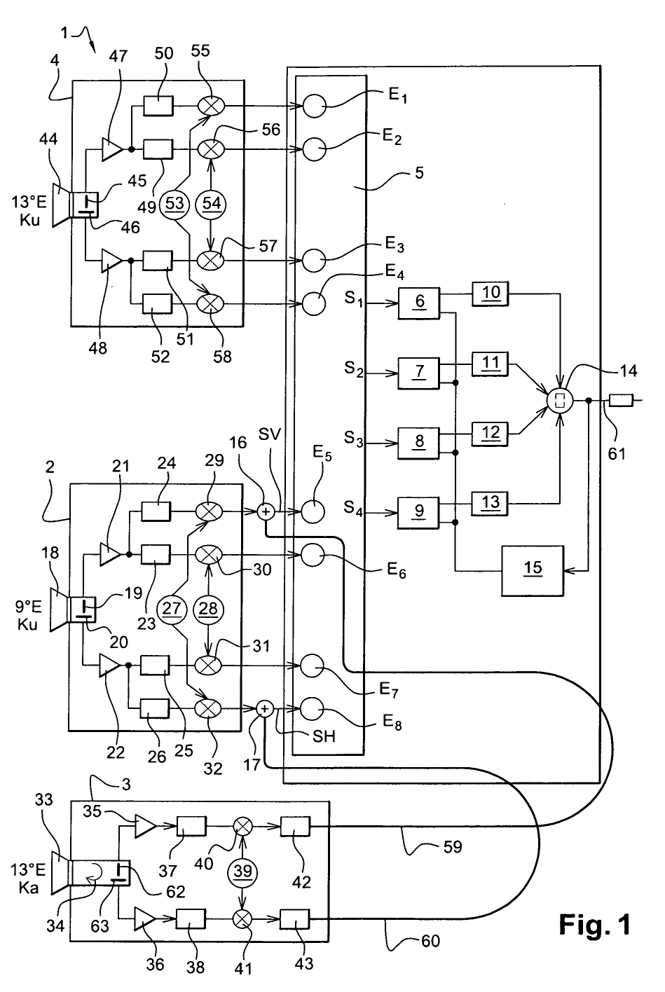

FIG. 1 represents an installation 1 for receiving radio satellite signals according to the invention. It will be noted that all the orbital positions and frequency bands described in the following are given purely for illustration purposes and that the device according to the invention may of course be applied to other orbital positions of satellites and to other frequency bands. Installation 1 comprises:

three LNB blocks 2, 3 and 4;

a selector 5 with eight inputs E1 to E8 and four outputs S1 to S4;

four mixer blocks 6, 7, 8 and 9,

four passband filters 10, 11, 12 and 13; a first electric coupler 16;

a second electric coupler 17;

a third electric coupler 14;

a control unit 15.

Installation 1 is connected via a single coaxial cable 61 to a processing unit, not represented, and is comprised of demodulation blocks, each demodulation block comprising, among other items, a channel selector and a demodulator.

Installation 1 is adapted for receiving bands from different satellites in the case of an antenna with multiple orbits: for example, a first satellite transmitting in Ku band in a first orbital position (13° East for example), a second satellite transmitting in Ku band in a second orbital position (9° East for example) and a third satellite transmitting in Ka band in the first orbital position (13° East).

The LNB 2 block comprises:

a horn 18 for receiving the microwave frequency radio signals transmitted by a satellite at 9° East in Ku band in a first initial frequency band B1 extending from 11.2 GHz to 12.75 GHz;

two antenna ends 19 and 20 to collect the radio signals received and transform them into two electrical signals representative of the signals received in vertical and horizontal linear polarization respectively;

two low-noise amplifiers 21 and 22 to respectively amplify the electrical signals representative of the signals received respectively in vertical and horizontal linear polarization;

two passband filters 23 and 24 coupled to the amplifier 21 and respectively allowing an electrical signal representative of a high frequency band signal in vertical polarization HV1 (11.7 GHz-12.75 GHz) and an electrical signal representative of a low frequency band signal in vertical polarization BV1 (11.2 GHz-11.7 GHz) to be obtained;

two passband filters 25 and 26 coupled to the amplifier 22 and respectively allowing a signal representative of a high frequency band signal in horizontal polarization HH1 (11.7 GHz-12.75 GHz) and a signal representative of a low frequency band signal in horizontal polarization BH1 (11.2 GHz-11.7 GHz) to be obtained;

two local oscillators 27 and 28, each generating a transposition signal at an oscillation frequency of 9.75 GHz and 10.6 GHz respectively;

a frequency mixer 29 having a first input to receive the output of the passband filter 24 and a second input to receive the signal generated by the local oscillator 27;

a frequency mixer 30 having a first input to receive the output of the passband filter 23 and a second input to receive the signal generated by the local oscillator 28;

a frequency mixer 31 having a first input to receive the output of the passband filter 25 and a second input to receive the signal generated by the local oscillator 28;

a frequency mixer 32 having a first input to receive the output of the passband filter 26 and a second input to receive the signal generated by the local oscillator 27.

The LNB 3 block comprises:

a horn 33 for receiving the microwave frequency radio signals transmitted by a satellite at 13° East in Ka band in a second initial frequency band B2 extending from 19.7 GHz to 20.2 GHz;

a Teflon sheet 34 forming a converter to convert a circular polarization signal into a linear polarization signal;

two antenna ends 62 and 63 to collect the linear polarization signals and convert them into two electrical signals representative of radio signals in vertical and horizontal linear polarization respectively;

two low-noise amplifiers 35 and 36 to amplify the signals in vertical and horizontal polarization respectively;

a passband filter 37 coupled to the amplifier 35 and allowing a signal equivalent to that from a satellite transmitting in vertical polarization BV2 (known subsequently as second passband in vertical polarization) ranging from 19.7 GHz to 20.2 GHz (corresponding to two frequency intervals [19.7 GHz; 19.95 GHz] and [19.95 GHz; 20.2 GHz] in the downlink frequency plan from the satellite to the receiver) to be respectively obtained;

a passband filter 38 coupled to the amplifier 36 and allowing a signal equivalent to that from a satellite transmitting in horizontal polarization BH2 (known as second low band in horizontal polarization) ranging from 19.7 GHz to 20.2 GHz (corresponding to two frequency intervals [19.7 GHz; 19.95 GHz] and [19.95 GHz; 20.2 GHz] in the downlink frequency plan from the satellite to the receiver) to be respectively obtained;

a local oscillator 39 generating a transposition signal at an oscillation frequency of 18.75 GHz;

a frequency mixer 40 having a first input to receive the output of the passband filter 37 and a second input to receive the signal generated by the local oscillator 39;

a frequency mixer 41 having a first input to receive the output of the passband filter 38 and a second input to receive the signal generated by the local oscillator 39;

a low pass filter 42 connected to the output of the frequency mixer 40;

a low pass filter 43 connected to the output of the frequency mixer 41.

The LNB 4 block comprises:

a horn 44 for the receipt of signals transmitted by a satellite at 13° East in Ku band in a third initial frequency band B3 extending from 10.7 GHz to 12.75 GHz (it will be noted that horn 33 may be concentric with horn 44);

two antenna ends 45 and 46 to transform the wave received into two electrical signals representative of the signals received in vertical and horizontal linear polarization respectively;

two low-noise amplifiers 47 and 48 to respectively amplify the electrical signals representative of the radio signals in vertical and horizontal polarization;

two passband filters 49 and 50 coupled to the amplifier 47 and allowing a signal equivalent to that from a satellite transmitting in high frequency band in vertical polarization HV3 (11.7 GHz-12.75 GHz) and a signal equivalent to that from a satellite transmitting in low frequency band in vertical polarization BV3 (10.7 GHz-11.7 GHz) to be obtained respectively;

two passband filters 51 and 52 coupled to the amplifier 48 and allowing a signal equivalent to that from a satellite transmitting in high frequency band in horizontal polarization HH3 (11.7 GHz-12.75 GHz) and a signal equivalent to that from a satellite transmitting in low frequency band in horizontal polarization BH3 (10.7 GHz-11.7 GHz) to be obtained respectively;

two local oscillators 53 and 54, each generating a transposition signal respectively at an oscillation frequency of 9.75 GHz and 10.6 GHz;

a frequency mixer 55 having a first input to receive the output of the passband filter 50 and a second input to receive the signal generated by the local oscillator 53;

a frequency mixer 56 having a first input to receive the output of the passband filter 49 and a second input to receive the signal generated by the local oscillator 54;

a frequency mixer 57 having a first input to receive the output of the passband filter 51 and a second input to receive the signal generated by the local oscillator 54;

a frequency mixer 58 having a first input to receive the output of the passband filter 52 and a second input to receive the signal generated by the local oscillator 53.

The outputs of mixers 55, 56, 57 and 58 of the LNB 4 block are respectively connected to inputs E1 to E4 of selector 5.

The outputs of mixers 30 and 31 of the LNB 2 block are respectively connected to inputs E6 and E7 of selector 5.

The output of the low pass filter 42 is connected to the input of the first microwave frequency coupler 16 via a cable 59 (it will be noted that if the device according to the invention is at least partially constructed on an electronic board, the cable may of course be replaced by a conductive track).

The signal from the output of the mixer 29 of the LNB 2 block is electrically added to the signal from the mixer 40 of the LNB 3 block (filtered by the low pass filter 42) via the first microwave frequency coupler 16: this sum signal is sent over the input E5 of the selector 5.

The output of the low pass filter 43 is connected to the input of the second microwave frequency coupler 17 via a cable 60 (again, if the device according to the invention is at least partially constructed on an electronic board, the cable may of course be replaced by a conductive track).

The signal from the output of the mixer 32 of the LNB 2 block is electrically added to the signal from the mixer 41 of the LNB 3 block (filtered by the low pass filter 43) via the second microwave frequency coupler 17: this sum signal is sent over the input E8 of the selector 5.

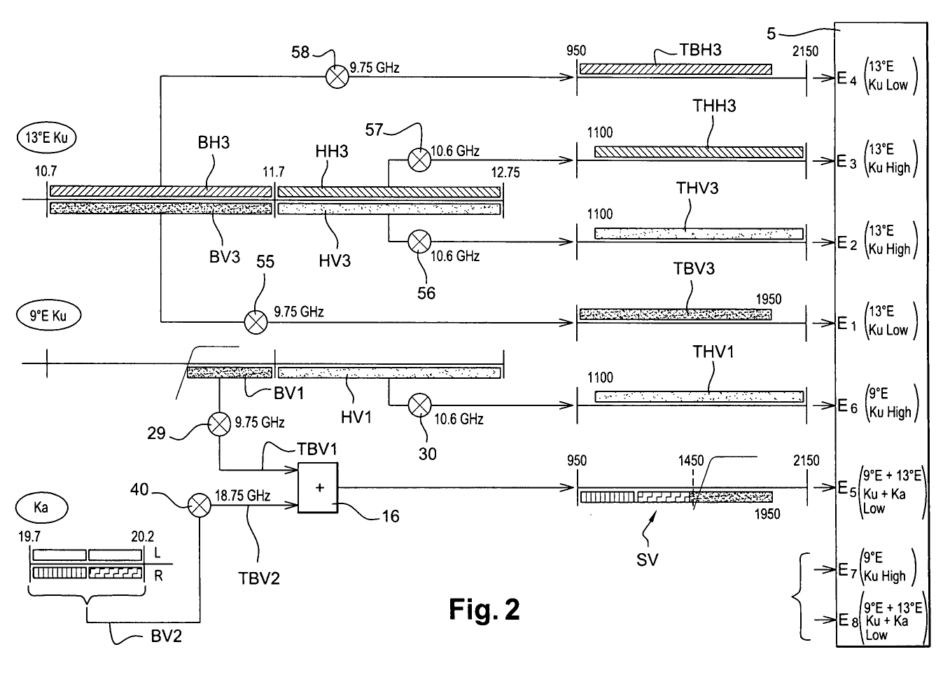

The construction of signals sent over the different inputs E1 to E8 of the selector 5 is illustrated by FIG. 2.

Concerning the satellite at 9° East in band Ku:

the first low band BV1 of 11.2 GHz to 11.7 GHz of the signal equivalent to that from a satellite transmitting in vertical polarization is converted into a first low intermediate band TBV1 ranging from 1450 MHz to 1950 MHz by the mixer 29 via the 9.75 GHz frequency of the local oscillator 27;

the first high band HV1 of 11.7 GHz to 12.75 GHz of the signal equivalent to that from a satellite transmitting in vertical polarization is converted into a first high intermediate band THV1 ranging from 1100 MHz to 2150 MHz by the mixer 30 via the 10.6 GHz frequency of the local oscillator 28;

the first high band HH1 (not represented in FIG. 2) of 11.7 GHz to 12.75 GHz of the signal equivalent to that from a satellite transmitting in horizontal polarization is converted into a first high intermediate band THH1 ranging from 1100 MHz to 2150 MHz by the mixer 31 via the 10.6 GHz frequency of the local oscillator 28;

the first low band BH1 (not represented in FIG. 2) of 11.2 GHz to 11.7 GHz of the signal equivalent to that from a satellite transmitting in horizontal polarization is converted into a first low intermediate band TBH1 ranging from 1450 MHz to 1950 MHz by the mixer 32 via the 9.75 GHz frequency of the local oscillator 27;

Concerning the satellite at 13° East in Ka band

the second low band BV2 of 19.7 GHz to 20.2 GHz of the signal equivalent to that from a satellite transmitting in vertical polarization is converted into a second low intermediate band TBV2 ranging from 950 MHz to 1450 MHz by the mixer 40 via the 18.75 GHz frequency of the local oscillator 39;

the second low band BH2 (not represented) of 19.7 GHz to 20.2 GHz of the signal equivalent to that from a satellite transmitting in horizontal polarization is converted into a second low intermediate band TBH2 ranging from 950 MHz to 1450 MHz by the mixer 41 via the 18.75 GHz frequency of the local oscillator 39.

The signal in first low intermediate band TBV1 and the signal in second low intermediate band TBV2 are electrically coupled by the microwave frequency adder 16 and the sum signal SV obtained covering a frequency band ranging from 950 MHz to 1950 MHz (knowing that the frequency band ranging from 950 MHz to 2150 MHz constitutes the usual band operable by the tuner of a terminal) is injected in input E5 of selector 5.

In addition, the signal in first low intermediate band TBH1 and the signal in second low intermediate band TBH2 are electrically coupled by the microwave frequency adder 17 and the sum signal SH obtained covering a frequency band ranging from 950 MHz to 1950 MHz is injected in input E8 of selector 5.

The Ka band is thus perceived by the reception part as simply being the low band of the satellite transmitting in Ku band at 9° East.

The signal corresponding to a first high intermediate band THV1 is injected in input E6.

The signal corresponding to a first high intermediate band THH1 is injected in input E7.

Concerning the satellite at 13° East in Ku band:

the third low band BV3 of 10.7 GHz to 11.7 GHz of the signal equivalent to that from a satellite transmitting in vertical polarization is converted into a third low intermediate band TBV3 ranging from 950 MHz to 1950 MHz by the mixer 55 via the 9.75 GHz frequency of the local oscillator 53; the signal corresponding to the third low intermediate band TBV3 is injected on the input E1;

the third high band HV3 of 11.7 GHz to 12.75 GHz of the signal equivalent to that from a satellite transmitting in vertical polarization is converted into a third high intermediate band THV3 ranging from 1100 MHz to 2150 MHz by the mixer 56 via the 10.6 GHz frequency of the local oscillator 54; the signal corresponding to the third high intermediate band THV3 is injected over the input E2;

the third high band THH3 of 11.7 GHz to 12.75 GHz of the signal equivalent to that from a satellite transmitting in horizontal polarization is converted to a third high intermediate band THH3 ranging from 1100 MHz to 2150 MHz by the mixer 57 via the 10.6 GHz frequency of the local oscillator 54; the signal corresponding to the third high intermediate band THH3 is injected over the input E3;

the third low band BH3 of 10.7 GHz to 11.7 GHz of the signal equivalent to that from a satellite transmitting in horizontal polarization is converted to a third low intermediate band TBH3 ranging from 950 MHz to 1950 MHz by the mixer 58 via the 9.75 GHz frequency of the local oscillator 53; the signal corresponding to the third low intermediate band TBH3 is injected in input E4.

The selector 5 thus receives as an input the signals transmitted by blocks 2, 3 and 4 according to the construction described in reference to FIG. 2 and is connected as an output to the four mixer blocks 6, 7, 8 and 9. The selector 5 may transmit any one of inputs E1 to E8 to any one of inputs of the four mixer blocks 6, 7, 8 and 9.

In response to the demand of the users transmitted by the coaxial cable 61, the control unit 15 transmits control signals to the mixer blocks 6, 7, 8 and 9, for example according to the communication protocol known under the registered trademark 12C (“Integrated Circuit Control”).

These control signals allow the selector 5 to be controlled such that one of the signals produced by blocks 2, 3 or 4 over inputs E1 to E8 is transmitted to one of the mixer blocks 6 to 9: this signal comprises the useful signal of the user associated with the block.

Each mixer block, respectively 6, 7, 8 and 9, is connected in series with a passband filter, respectively 10, 11, 12 and 13. Each passband filter, respectively 10, 11, 12 and 13, is possibly connected in series with an isolation amplifier, not represented.

Each mixer block, respectively 6, 7, 8 and 9 comprises a frequency synthesizer. The control unit 15 also controls the frequency synthesizer of each mixer block 6 to 9 so that it produces an adapted mixing frequency such that the signal received by the mixer block 6 to 9 is correctly shifted in frequency so that the frequency band of the “useful” signal, after passage by the mixer block, is included in the bandwidth of the passband filter 10 to 13 respectively associated with the mixer block 6 to 9.

Each block 6 to 9 thus carries out a shifting operation of the signal from the intermediate frequency band in a frequency band that completely or in part overlaps the transmission band of between 950 MHz and 2150 MHz. The intermediate frequency band is chosen so as to limit the formation of parasitic signals during the shifting operation.

Each filter 10 to 13 then filters the shifted signal and retains a portion (known as the “user band”) of the shifted frequency band included in the transmission band comprising the useful signal spectrum. The different portions of the transmission band or “user band” are added via the coupler 14 to form a signal whereof the frequency band substantially corresponds to the transmission band. This signal is then transmitted via the coaxial cable 61 to the demodulation units, not represented, adapted to extract and process in the transmission band signal a signal corresponding to one of the portions of the transmission band.

It will be noted that it is possible to use two concentric horns 44 and 33 for the reception of two satellites at 13° East respectively in Ku and Ka band.

Of course, the invention is not limited to the embodiment that has just been described.

Thus, the embodiment described above mentions a local oscillator 27 generating a transposition signal at an oscillation frequency of 9.75 GHz. However, it is perfectly possible to use another oscillation frequency. Typically, an oscillation frequency equal to 9.55 GHz may thus be used. In this case, the band from 11.2 GHz to 11.7 GHz is converted into a band ranging from 1650 MHz to 2150 MHz. Thus, according to such a configuration, a guard band of 200 MHz ensures coupling between the band ranging from 950 MHz to 1450 MHz generated via the local oscillator 39 at 18.75 GHz and the band ranging from 1650 MHz to 2150 MHz generated via the local oscillator 27 at 9.55 GHz.

In addition, the invention was more particularly described in the case of a selector with 8 inputs and 4 outputs, but it may be applied to other types of selectors (for example with 8 inputs and 8 outputs).

In addition, according to the embodiment described, the signal in first low intermediate band TBV1 (from a radio signal in vertical polarization) and the signal in second low intermediate band TBV2 (from a radio signal in vertical polarization) are electrically coupled by the microwave frequency adder 16. Furthermore, the signal in low intermediate band TBH1 (from a radio signal in horizontal polarization) and the signal in second low intermediate band TBH2 (from a signal in horizontal polarization) are electrically coupled by the microwave frequency adder 17. Thus, according to the embodiment described above, the added signals are each from signals having the same polarization. However, it is perfectly possible to add signals from radio signals having different polarization. By way of example, the adder 16 would couple in this case the signal in first low intermediate band TBV1 (from a radio signal in vertical polarization) and the signal in second low intermediate band TBH2 (from a signal in horizontal polarization) and the adder 17 would couple the signal in first low intermediate band TBH1 (from a radio signal in horizontal polarization) and the signal in second low intermediate band TBV2 (from a radio signal in vertical polarization). The signals added are in fact electrical signals without polarization and may thus be from signals having different polarizations. In other words, according to this new embodiment, the first electric adder 16 adds the first transposed signal to the first intermediate band from the first electrical signal representative of the first initial radio signal according to a first vertical polarization and the second transposed signal to the second intermediate band from the second electrical signal representative of the second initial radio signal according to a first horizontal polarization. The second electric adder adds the first transposed signal to the first intermediate band from the first electrical signal representative of the first initial radio signal according to a second horizontal polarization and the second transposed signal to the second intermediate band from the second electrical signal representative of the second initial radio signal according to a second vertical polarization.

Lastly, even if the invention finds a particularly interesting application for receiving Ka and Ku bands by using the UNICABLE™ solution in its current configuration, it is also possible to use the invention for other frequency bands.

What is claimed is:

1-11. (canceled)

12. An installation for receiving microwave frequency radio satellite signals, comprising:
a first block including:
first means for transforming:
a first initial radio signal according to a first polarization from a first satellite in a first frequency band into a first electrical signal representative of said first initial radio signal according to a first polarization and,
a first initial radio signal according to a second polarization from said first satellite in said first frequency band into a first electrical signal representative of said first initial radio signal according to a second polarization;
a first local oscillator to generate a first transposition signal at a given oscillation frequency;
a first frequency mixer having:
a first input to receive said first electrical signal representative of said first initial radio signal according to a first polarization and,
a second input receiving said first transposition signal such that said first mixer shifts the first initial frequency band of the first electrical signal representative of said first initial radio signal according to a first polarization to a first intermediate frequency band;
a second frequency mixer having:
a first input to receive said first electrical signal representative of said first initial radio signal according to a second polarization and, * a second input receiving said first transposition signal such that said second mixer shifts the first initial frequency band of the first electrical signal representative of said first initial radio signal according to a second polarization to said first intermediate frequency band;
a second block including:
a second local oscillator to generate a second transposition signal at a given oscillation frequency;
second means to transform:
a second initial radio signal according to a first polarization from a second satellite in a second frequency band into a second electrical signal representative of said second initial radio signal according to a first polarization and,
a second initial radio signal according to a second polarization from said second satellite in said second frequency band into a second electrical signal representative of said second initial radio signal according to a second polarization;
a third frequency mixer having:
a first input to receive said second electrical signal representative of said second initial radio signal according to a first polarization and,
a second input receiving said second transposition signal such that said third mixer shifts the second initial frequency band of the second electrical signal representative of said second initial radio signal according to a first polarization to a second intermediate frequency band;
a fourth frequency mixer having:
a first input to receive said second electrical signal representative of said second initial radio signal according to a second polarization and,
a second input receiving said second transposition signal such that said fourth mixer shifts the second initial frequency band of the second electrical signal representative of said second initial radio signal according to a second polarization to said second intermediate frequency band;
a first electric adder to add the first transposed signal to said first intermediate band from the first electrical signal representative of said first initial radio signal according to a first polarization and the second transposed signal to said second intermediate band from said second electrical signal representative of said second initial radio signal according to a first polarization;
a second electric adder to add the first transposed signal to said first intermediate band from said first electrical signal representative of said first initial radio signal according to a second polarization and the second transposed signal to said second intermediate band from said second electrical signal representative of said second initial radio signal according to a second polarization.

13. The installation according to claim 12 wherein said oscillation frequencies of said first and second local oscillators are chosen such that said first and second intermediate bands are substantially adjacent.

14. The installation according to claim 12 wherein said second block comprises:
a horn for the receipt:
of said second initial radio signal according to a first polarization from a second satellite in said second frequency band;
of said second initial radio signal according to a second polarization from said second satellite in said second frequency band;
a converter to convert a circular polarization signal into a linear polarization signal;
two amplifiers to respectively amplify:
said second electrical signal representative of said second initial radio signal in vertical polarization and,
said second electrical signal representative of said second initial radio signal in horizontal polarization.

15. The installation according to claim 12 wherein said first frequency band is the Ku band and said second frequency band is the Ka band.

16. The installation according to claim 12 wherein:
said first local oscillator generates a first transposition signal at a frequency of 9.75 GHz;
said second local oscillator generates a second transposition signal at a frequency of 18.75 GHz.

17. The installation according to claim 12 wherein said installation is intended to produce a signal in a transmission band to be transmitted over a coaxial cable and said first block comprises:
a horn for the reception:
of an initial radio signal in vertical polarization from a first satellite in a first frequency band;
of an initial radio signal in horizontal polarization from said first satellite in said first frequency band;
and wherein said first means transforms:
said initial radio signal from the first satellite in vertical polarization in said first frequency band into an electrical signal,
said initial radio signal from said first satellite in horizontal polarization in said first frequency band into an electrical signal;
first and second amplifiers to respectively amplify said electrical signals;
first and second passband filters coupled to said first amplifier and respectively allowing a first high frequency band signal representative of said initial radio signal from the first satellite in high frequency band in vertical polarization and a first low frequency band signal representative of said initial radio signal from the first satellite in low frequency band in vertical polarization to be obtained, said first mixer shifting said first low frequency band signal representative of said initial radio signal from the first satellite in low frequency band in vertical polarization to said first low intermediate frequency band;
third and a fourth passband filters coupled to said second amplifier and respectively allowing a first high frequency band signal representative of said initial radio signal from the first satellite in high frequency band in horizontal polarization and a first low frequency band signal representative of said initial radio signal from the first satellite in low frequency band in horizontal polarization to be obtained, said second mixer shifting said first low frequency band signal representative of said initial radio signal from the first satellite in low frequency band in horizontal polarization to said first low intermediate frequency band;
a third oscillator generating a third transposition signal at a given oscillation frequency;
a fifth frequency mixer having a first input to receive the output of said first passband filter and a second input to receive the signal generated by said third local oscillator such that said fifth mixer shifts the high frequency band signal representative of said initial radio signal from the first satellite in high frequency band in vertical polarization to a first high intermediate frequency band;
a sixth frequency mixer having a first input to receive the output of said third passband filter and a second input to receive the signal generated by said third local oscillator such that said sixth mixer shifts the high frequency band signal in horizontal polarization representative of said initial radio signal from the first satellite in high frequency band in horizontal polarization to the first high intermediate frequency band;
said first frequency mixer receiving on its first input the output of said second passband filter and said second frequency mixer receiving on its first input the output of said fourth passband filter, said installation comprising:
a selector including at least 4 inputs to respectively receive the signals produced by said first electric adder, said fifth frequency mixer, said sixth frequency mixer and said second electric adder, said selector may select several signals from among the signals received;
for each signal selected, a mixer capable of transforming the selected signal into a signal at least in part in the transmission band, and a filter capable of extracting from the transformed signal a signal associated with a portion of the transmission band from among several portions of the transmission band;
a third adder to form said signal in the transmission band to be transmitted over said coaxial cable from the signals associated with portions of said transmission band.

18. The installation according to claim 17 wherein said third local oscillator generates a third transposition signal at a frequency of 10.6 GHz.

19. The installation according to claim 17 wherein:
the first high frequency band of said first electrical signals in high frequency band representative of initial radio signals from the first satellite in high frequency band, respectively in vertical and horizontal polarization, is between 11.7 GHz and 12.75 GHz;
the first low frequency band of said first electrical signals in low frequency band representative of initial radio signals from the first satellite in low frequency band, respectively in vertical and horizontal polarization, is between 11.2 GHz and 11.7 GHz;
the second frequency band of said second electrical signals is between 19.7 GHz and 20.2 GHz;
said first low intermediate frequency band is between 1450 MHz and 1950 MHz;
said first high intermediate frequency band is between 1100 MHz and 2150 MHz;
said second intermediate frequency band is between 950 MHz and 1450 MHz.

20. The installation according to claim 17 wherein the installation comprises a third block including:
a further horn for the receipt:
of a third initial radio signal according to a vertical polarization from a third satellite in a third initial frequency band;
of a third initial radio signal according to a horizontal polarization from a third satellite in a third initial frequency band;
third means to transform:
said initial radio signal from said third satellite in vertical polarization in a third frequency band into an electrical signal;
said initial radio signal from said third satellite in horizontal polarization in the third frequency band into an electrical signal;
third and fourth amplifiers to respectively amplify said electrical signals;
fifth and sixth passband filters coupled to said third amplifier and respectively allowing a third high frequency band signal representative of said initial radio signal from the third satellite in high frequency band according to vertical polarization and a third low frequency band signal representative of said initial radio signal from the third satellite in low frequency band according to the vertical polarization to be obtained,
seventh and eighth passband filters coupled to said fourth amplifier and respectively allowing a third high frequency band signal representative of said initial radio signal from the third satellite in high frequency band according to the horizontal polarization and a third low frequency band signal representative of said initial radio signal from the third satellite in low frequency band according to the horizontal polarization to be obtained;
a fourth oscillator generating a fourth transposition signal at a given oscillation frequency;
a fifth oscillator generating a fifth transposition signal at a given oscillation frequency;
a seventh frequency mixer having a first input to receive the output of said sixth passband filter and a second input to receive the signal generated by said fourth local oscillator such that said seventh mixer shifts the third low frequency band signal representative of said initial radio signal from the third satellite in low frequency band according to the vertical polarization to a third high intermediate frequency band;
an eighth frequency mixer having a first input to receive the output of said fifth passband filter and a second input to receive the signal generated by said fifth local oscillator such that said eighth mixer shifts the third high frequency band signal representative of said initial radio signal from the third satellite in high frequency band according to the vertical polarization to a third high intermediate frequency band;
a ninth frequency mixer having a first input to receive the output of said seventh passband filter and a second input to receive the signal generated by said fifth local oscillator such that said ninth mixer shifts the third high frequency band signal representative of said initial radio signal from the third satellite in high frequency band according to the horizontal polarization to the third high intermediate frequency band;
a tenth frequency mixer having a first input to receive the output of said eighth passband filter and a second input to receive the signal generated by said fourth local oscillator such that said tenth mixer shifts the third low frequency band signal representative of said initial radio signal from the third satellite in low frequency band according to the horizontal polarization to the third low intermediate frequency band;
said selector including eight inputs to respectively receive the signals produced by said seventh frequency mixer, said eighth frequency mixer, said ninth frequency mixer, said tenth frequency mixer, said first electric adder, said fifth frequency mixer, said sixth frequency mixer and said tenth electric adder.

21. The installation according to claim 20 wherein said third frequency band is the Ku band, said fourth local oscillator generates a first transposition signal at a frequency of 9.75 GHz and said fifth local oscillator generates a second transposition signal at a frequency of 10.6 GHz.

22. The installation according to claim 12 wherein said first means comprises two antenna ends.

23. The installation according to claim 22 wherein said second means comprises two further antenna ends.

24. The installation according to claim 20 wherein said first, second and third means each comprises two antenna ends.
